(19) United States
(12) Patent Application Publication
(10) Pub. No.: US 2004/0093537 A1
(43) Pub. Date: May 13, 2004

(54) System for determining computer program memory allocation and deallocation

(76) Inventors: Ryan C. Thompson, Fort Collins, CO (US); John W. May, LaPorte, CO (US)

Correspondence Address: HEWLETT-PACKARD COMPANY, Intellectual Property Administration, P.O. Box 272400, Fort Collins, CO, 80527-2400, US

(21) Appl. No.: 10/291,935

(22) Filed: Nov. 11, 2002

(51) Int. Cl. G06F 11/00

(52) U.S. Cl. 714/38

(57) ABSTRACT

A system for indicating attempts by a computer program to free memory that is not currently allocated, as well as indicating allocated memory that is never freed. In a particular software program, the programmer includes code that prints a short debug message to a text file every time that a memory allocation or a free-memory operation takes place. After the program completes execution, the text file contains a list of messages indicating all occurrences of memory allocation or free-memory operations. An automated parsing function examines the text file and provides error indications when memory allocation or de-allocation errors are detected.

### TECHNICAL FIELD

The present invention relates generally to computer systems, and more particularly, to a system for determining memory allocation and de-allocation operation by a computer program.

### BACKGROUND

When a software program is executing, it is necessary for the program to request memory space from the computer on which the program is running in order to have space for the program to store data internally while executing the program. In certain programming languages the programmer must write code to allocate memory when the program needs it for internal use. The programmer must write code to free the memory so that it can be allocated to the same or another program, when the program has finished using the allocated memory.

In some computer programs, particularly in larger and more complex programs, there are many places where memory is allocated and freed. Problems of undefined and undesired behavior can occur with program execution when memory is not allocated or freed correctly. More specifically, two of these problems are:

Memory is allocated but never freed when it is no longer needed:

This can eventually cause the computer to run out of available memory space, causing undefined and undesired behavior of the program or of the computer system.

The program attempts to free memory that is not allocated. It may be that the memory space in question was never allocated, or it may have been allocated, but already freed. This can also cause undefined and undesired behavior.

Furthermore, previously existing methods require the program of interest to be recompiled in order to activate the debugging features.

### SUMMARY

The present system allows a programmer to determine whether a program has left memory in an allocated state after it is no longer needed, and also provides an indication of the existence of free memory that has not been allocated. In a particular software program, the programmer includes code that prints a short debug message to a text file every time that a memory allocation or a free-memory operation takes place. To determine whether the program is exhibiting one of the problem behaviors noted above, the program is run with a parameter that tells the program to write the debug messages to a text file. After the program completes execution, the text file will contain a list of messages indicating all occurrences of memory allocation or free-memory operations.

### BRIEF DESCRIPTION OF THE DRAWINGS

FIG. 1 is a diagram illustrating components in an exemplary embodiment of a computer system configured in accordance with the present system; and

FIG. 2 is a flowchart illustrating exemplary steps which may be performed in practicing one embodiment of the present system.

### DETAILED DESCRIPTION

During the execution of a software program, it is generally necessary for the program to request memory space from the computer on which the program is running in order to have space for the program to store data internally while executing. When using certain programming languages (‘C’, for example) the author of a software program (hereinafter termed the ‘programmer’) must explicitly write code to allocate memory when it is needed for internal use. The programmer must also write code to free the memory so that it can be allocated to the same program or another program when the program has finished using the allocated memory.

The present system indicates or reports that memory may need to be freed, or that unallocated memory was freed. Using the present system, the programmer includes, in a particular software program, code that writes a short debug message to a text file every time that a memory allocation or a free-memory operation occurs (e.g., when an ‘allocate memory’ or ‘de-allocate memory’ command is executed). To determine whether the program is exhibiting a problem behavior such as not freeing allocated memory when it is no longer needed, or attempting to free memory that is not allocated, the program is run with an input parameter that instructs the program to write the debug messages to a text file (‘text debug file’). After execution of the program is complete, the text file contains a list of messages indicating all instances of execution of memory allocation or free-memory commands. The programmer can then use the information in the text file to determine whether It the memory space in question was never allocated, or possibly allocated, but already freed.

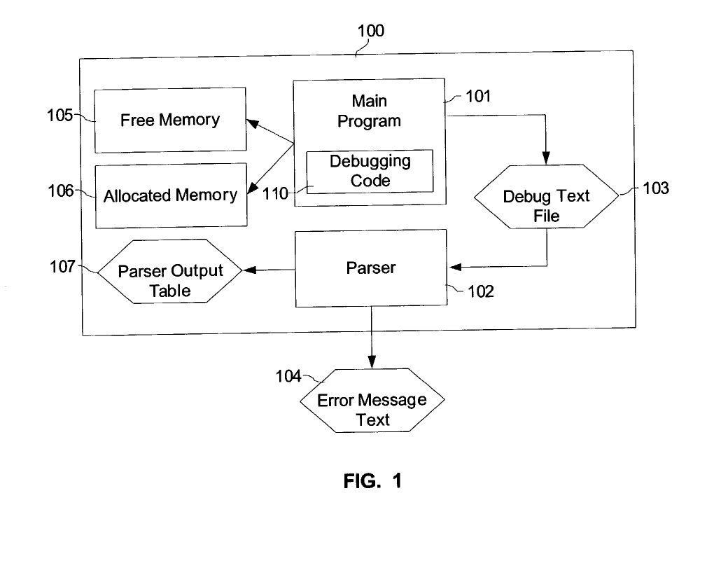

FIG. 1 is a diagram illustrating exemplary components in a computer system configured in accordance with the present system. As shown in FIG. 1, memory 100 in the computer system includes a main program 101, including debugging code 110 that creates a debug text file 103 used by parser program 102, to generate an internal parser output table 107 and error message text 104, as explained in detail below. During operation, main program 101 allocates a segment of free memory 105 to generate allocated memory 106, all or part of which is subsequently freed to again become free memory 105.

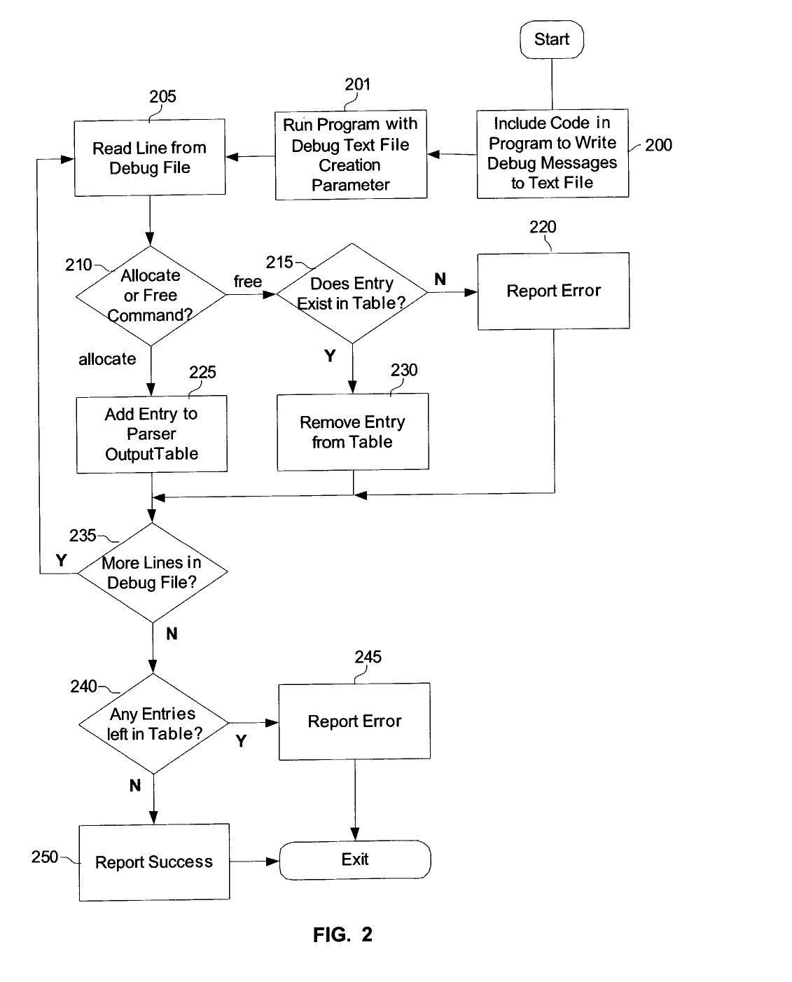

The present system provides a method for parsing a text file containing debug messages and locating error conditions such as those described above. FIG. 2 is a flowchart illustrating exemplary steps which may be performed in practicing one embodiment of the method of the present invention. As shown in FIG. 2, initially, at step 200, debugging code 110 is included in the program 101 of interest. This code 110 executes in response to a debug mode parameter, received by the program at execution time, for activating the present debugging method. In an exemplary embodiment, program 101 uses the debug mode parameter to turn on the debug function via a conditional ‘write’ (trace) function for the memory allocation commands, and a corresponding function for the memory de-allocation commands, where the conditional functions use a boolean value (set by the input parameter) to determine whether to cause debugging messages to be written to the debug text file 103. One method for activating the present debugging feature, used in a ‘C’ programming language environment, is to pass a ‘−d’ parameter (which sets a debug flag) on the command line when running the program. This provides a mechanism for determining whether to write messages to the debug text file 103. There are several ways in which a boolean parameter may be used to cause the messages to be written to the debug text file. In one embodiment in which the ‘c’ programming language is used, each of the memory allocation commands in debugging code 110 calls a single function as shown in Table 1:

TABLE 1

```
Memory Allocation Function/Commands
mallocx(<args>, “<tag>”)
Each of the memory allocation (mallocx) commands then calls a
‘mallocx’ function:
mallocx(args, tag){
  if (debugflag)
      write_to_debug_file(args, tag)
  malloc(args)
}
```

In the present embodiment, the memory de-allocation (free) commands call a ‘freex( )’ function, analogous to the above ‘mallocx’ function. This method eliminates duplicated code throughout the program 101.

The program 101 checks for the presence of this debug mode parameter at runtime, thereby allowing the debugging method of the present system to be optionally enabled or disabled without having to recompile the program for each situation. When the debugging code 110 executes, it causes a message (described below) to be written to debug text file 103 every time a memory allocation or de-allocation command is executed. The debug mode parameter may also be passed to program 101 at execution time, where the parameter is set to indicate that the present debugging method is to be disabled or de-activated when the program is run. The debug mode parameter may, for example, have a boolean value that is used to determine whether the debugging code 110 is executed when program 101 is run.

The ‘C’ programming language, for example, includes a command used for allocating memory, called a “malloc” (memory-allocate) command. A “free” command is used for de-allocating memory that has been allocated. In an exemplary embodiment in which the ‘c’ programming language is used, the memory allocation/de-allocation debug messages printed to the debug text file 103 include memory address indicia and other information shown in Table 2, below:

TABLE 2
Debug Text File Messages

‘malloc’ commands:
<address> <ord num> <num bytes> malloc <tag>
‘free’ commands:
<address> <ord num> free <tag>
Where:

address - the address of the memory allocation or de-allocation

operation, i.e., the address of the memory segment allocated (for
‘malloc’s) or the address to be freed (for ‘free’s).

ord num - the ordinal number of the line (i.e., the message) in

the debug text file. The first line in the debug file has ordinal number 0,
the second line has ordinal number 1, and so forth.

num bytes - the number of bytes of memory allocated.
tag - a text tag can be any string designated by the

programmer. Typically, a tag is expressed in the form of
“<functionname> <location>”, where <functionname> is the name of
the function in which the malloc or free command is located, and
<location> is some description of the location within that function. An
example of a tag is “read_in_data_file( ) after the third loop”. The tag is
used by the programmer to determine which malloc/free statement in a
program caused a particular malloc or free operation to be executed.

Although the programmer may manually inspect the debug text file 103, in a large program there may be many thousands (or millions) of malloc/free entries in the file. Therefore it is useful, if not practically necessary, to be able to automatically scan the debug text file 103 for possible error conditions.

At step 201, program 101 is executed with a debug mode parameter that enables the debugging code 110 to cause debug messages, such as those shown in Table 2, to be written to debug text file 103. After the program 101 has completed execution, the following steps 205-235 are then performed for each line in the debug text file. At step 205, parser 102 reads a line from debug text file 103. At step 210, the line is parsed to determine whether the indicated command is a memory allocation command or a memory de-allocation command. If the line indicates an allocation command was executed, then at step 225 parser 102 creates an entry in a parser output table 107, including the address and number of bytes of memory being allocated. If the line in the debug text file 103 indicates that a de-allocation command was executed, then parser output table 107 is searched for a corresponding entry, i.e., an entry with a matching address, at step 215. If the entry is found, it is removed from the parser output table 107, at step 230. If the entry is not found, then at step 220 an error condition is reported via a message 104 that indicates that the program 101 trying to free an memory segment that has not been allocated.

At step 235, if there are additional lines in debug text file 103 that have not been parsed, parser 102 continues to examine each line in the file by again performing steps 205-235, as described above. When the parser 102 reaches the end of the text file, a check is made at step 240 to determine whether there are any entries remaining in parser output table 107 which were not freed when program 101 terminated execution. If any entries still exist in the parser output table 107 at this point, then, at step 245, an error is reported via a message 104 indicating any entries that were allocated but which were never freed. Once errors are reported, the programmer may view the tags for the entries associated with the error to determine where in the program 101 to begin looking for program errors. If no entries are present in the parser output table 107, then at step 250, a success message 104 is reported indicating that program 101 properly handled the memory allocation and de-allocation functions.

While exemplary embodiments of the present invention have been shown in the drawings and described above, it will be apparent to one skilled in the art that various embodiments of the present invention are possible. For example, the specific configuration of program memory 100 as well as the particular set of steps set forth in FIG. 2 and described above should not be construed as limited to the specific embodiments described herein. Modification may be made to these and other specific elements of the invention without departing from its spirit and scope as expressed in the following claims.

What is claimed is:

1. A system for automatically determining memory allocation and de-allocation operations performed by a computer program during the execution thereof, the system comprising the steps of:
executing the program and debugging code included therein to cause the program to write a message to a debug file each time a memory allocation command or de-allocation command is executed by the program, wherein each said message includes indicia corresponding to a respective said command;
parsing each said message in the debug file to determine which type of said command is indicated by the message;
adding an entry to a table, for each said allocation command in the debug file, wherein each said entry comprises said indicia corresponding to the allocation command;
removing from said table, each said entry having said indicia corresponding to a respective said de-allocation command in the debug file; and
reporting an error message comprising each said entry remaining in the table, after each said message in the debug file has been parsed.

2. The system of claim 1, wherein said indicia includes an address and a size of a memory segment allocated by each said allocation command.

3. The system of claim 1, wherein said indicia includes an address of a memory segment freed by each said de-allocation command.

4. The system of claim 1, wherein a debug mode parameter is input to the program prior to execution thereof to cause the program to execute said debugging code.

5. The system of claim 4, wherein said program is compiled with said debugging code contained therein, to allow said debugging code to be enabled by said parameter without recompilation of the program.

6. The system of claim 4, wherein said debug mode parameter is set to a value to cause the program to disable creation of the debug file.

7. The system of claim 1, wherein, in the removing step, if said entry having said indicia corresponding to the respective de-allocation command does not exist, then an error message is generated for the de-allocation request corresponding to the de-allocation command.

8. A system for automatically determining memory allocation and de-allocation operations performed by a computer program during the execution thereof, the system comprising the steps of:
inputting a debug mode parameter instructing the program to write debug messages to a debug text file;
creating, in response to said parameter, said debug text file comprising a plurality of said debug messages collectively indicating each memory allocation command and memory de-allocation command executed by the program, wherein each of said messages includes indicia corresponding to a respective said command; and
after execution of the program:
parsing each of the messages in the debug text file to determine which type of said command is indicated by a respective one of the messages, and for each parsed message:
if said memory allocation command is indicated, then adding, to a table, an entry comprising indicia of the memory allocation command; and
if said memory de-allocation command is indicated, then removing from said table, a corresponding said entry having said indicia corresponding to said de-allocation command, if said corresponding entry exists; otherwise, if no said corresponding entry exists, then generating an error message for the de-allocation request corresponding to the de-allocation command; and
generating an error message comprising each said entry remaining in the table, after each said message in the debug text file has been parsed.

9. The system of claim 8, wherein said indicia includes an address and a size of a memory segment allocated by each said allocation command.

10. The system of claim 8, wherein said indicia includes an address of a memory segment freed by each said de-allocation command.

11. The system of claim 8, including the additional step of including code in the program responsive to the inputting of said parameter to cause the program to write said debug messages to the debug text file.

12. The system of claim 8, wherein said program is compiled with said debugging code contained therein, to allow said debugging code to be enabled by said parameter without recompilation of the program.

13. The system of claim 8, wherein said debug mode parameter is set to a value to cause the program to disable the writing of said debug messages.

14. A system for automatically determining memory allocation and de-allocation operations performed by a computer program during the execution thereof, the system comprising:
code means, responsive to an input parameter, for causing the program to write a message to a debug file, each time a memory allocation command or a memory de-allocation command is executed by the program, wherein each said message includes indicia corresponding to a respective said command;
code means for parsing each said message in the debug file to determine whether the message indicates said allocation command or said de-allocation command;
code means for adding an entry comprising said indicia to a table, for each said allocation command in the debug file;
code means removing from said table, each said entry having said indicia corresponding to each said de-allocation command in the debug file; and
code means for reporting an error message comprising each said entry remaining in the table, after each said message in the debug file has been parsed.

15. The system of claim 14, wherein said input parameter is set to a value to cause the program to disable the writing of said message to said debug file.

16. The system of claim 14, wherein the program is compiled with all of said code means included, to allow said code means to be enabled without recompilation of the program.

17. A system for automatically determining memory allocation and de-allocation operations performed by a computer program during the execution thereof, the system comprising:
debugging code, responsive to a debug mode parameter input to the program, for causing the program to write a message to a debug file corresponding to each execution of a memory allocation command and to each execution of a memory de-allocation command by the program, wherein each said message includes indicia corresponding to a respective said command;
a parser output table;
a parser for examining each said message in the debug file to determine whether the message indicates a memory allocation command or de-allocation command;
wherein said parser adds an entry to said output table for each said message in the debug file determined to indicate an instance of said allocation command;
wherein said parser removes from said output table, each said entry in the table having said indicia corresponding to a particular said message in the debug file determined to indicate an instance of said de-allocation command; and
wherein said parser reports an error message comprising each said entry remaining in the output table, after each said message in the debug file has been parsed.

18. The system of claim 17, wherein said indicia includes an address and a size of a memory segment allocated by each said allocation command.

19. The system of claim 17, wherein said indicia includes an address of a memory segment freed by each said de-allocation command.

20. The system of claim 17, wherein said program is compiled with said debugging code included, to allow said debugging code to be enabled without recompilation of the program.

21. The system of claim 17, wherein said debug mode parameter is set to a value to cause the program to disable the writing of said messages to said debug file.

22. The system of claim 17, wherein, if said entry in the table having said indicia corresponding to a particular said message in the debug file does not exist, then an error message is generated for the de-allocation request corresponding to the de-allocation command.
